(19) United States
(12) Patent Application Publication
(10) Pub. No.: US 2012/0041579 A1
(43) Pub. Date: Feb. 16, 2012

(54) REAR SURROUND SOUND PROJECTION SYSTEM

(76) Inventors: Charles Davis, Trabuco Canyon, CA (US); Shigenori Teramatsu, Irvine, CA (US)

(21) Appl. No.: 12/855,028

(22) Filed: Aug. 12, 2010

(51) Int. Cl. G06F 17/00

(52) U.S. Cl. 700/94

(57) ABSTRACT

Systems and methods that facilitate the use and operation of a sound projection system comprising a television with an integral sound projector and a rear room sound projector coupled to the television. The sound projectors preferably comprise arrays of speakers configurable to project beams that reflect off the walls and ceiling of the room to create surround sound or are directed to desired listening positions.

### FIELD OF THE INVENTION

The subject matter described herein relates generally to televisions and sound projection systems and more particularly to systems and methods that facilitate use and operation of a television with an integral sound projection system, and the use and operation of a rear surround projection system.

### BACKGROUND INFORMATION

As the capabilities of the TV and other components increase and become more affordable, more and more consumers will seek a true surround sound. Surround sound generally refers to the application of multi-channel audio to channels “surrounding” the audience in some combination of left surround, right surround, and rear surround as opposed to “screen channels” such as center, front left, and front right. In 4.0 channel or higher surround, the system will typically include a center channel speaker, a left front channel speaker and a right front channel speaker, two or more surround channel speakers in the rear or rear and side, and a low frequency effect channel to drive a subwoofer. For example, in 5.1 channel surround, the system typically includes a center channel speaker, a left front channel speaker and a right front channel speaker, two surround channel speakers in the left rear and right rear, and a low frequency effect channel to drive a subwoofer.

Currently, a consumer needs a high end audio-video receiver (AVR) in order to drive the sound system speakers. The AVR includes a decoder that will, depending on the audio source, extract from the audio signal a number of channels corresponding to the number of available speakers or deliver a discrete number of audio channels corresponding to the available speakers. For example, in a 5.1 channel surround system, the decoder will, depending on the audio source, extract five audio channels and one LFE channel from either a specially encoded two-channel source or a stereo source and distribute to the five speakers and one sub-woofer or deliver five discrete audio channels and one LFE channel from a 6 channel source to the five speakers and one sub-woofer. However, for the consumer, the addition of an AVR component and multiple speakers adds another level of complexity to their home entertainment system, the control of which can often be fraught with frustration.

Recent advances in sound projection technology from Cambridge Mechatronics Limited (CML) of Cambridge, England, eliminates the need for an AVR component and multiple speakers positioned around the room and wire coupled or wireless coupled to the AVR. In accordance with CML's sound projection technology, beams of sound emanate from an array of speakers mounted in a single enclosure, i.e., a sound projector, into the room in which the sound projector is positioned and reflect off the walls and ceiling of the room creating surround sound within the room. In addition, the sound projector is capable of beaming one or more beams of sound to targeted locations within the room. See, e.g., EP 1921890A2, U.S. 2006/0204022A2, WO 02/078388A2, WO 2007/007083A1 and U.S. 2004/0151325A1, which are incorporated herein by reference.

Currently, the sound projector is a stand alone component separate from the TV, with microprocessor control, and controllable by the user with a custom universal remote control unit with additional processor capabilities. Also, rear surround audio channel performance tends to be weak using traditional sound projector technology in larger rooms or room configurations lacking a rear wall in the room in which the TV is being viewed.

Accordingly, it would be desirable to provide a TV with an integral sound projection system that is controlled by the TV microprocessor control system and controllable and configurable by the user with a TV remote control unit on the TV layer of the remote control unit. It would be further desirable to provide a sound projection system that improves rear surround and left and right audio channel performance over conventional sound projection systems.

### SUMMARY

The embodiments provided herein are directed to systems and methods that facilitate the use and operation of a television with an integral sound projection system. In one embodiment, a television includes an integral sound projection system incorporating an array of speakers operable to create surround sound within a room and project one or more sound beams to targeted locations. The television preferably comprises audio and video input connections and audio-video outputs such as a sound projector and a video display screen coupled to a control system. The control system includes a micro processor and non-volatile memory upon which system control software is stored, an on screen display (OSD) controller coupled to the micro processor and the video signal input connections, an image display engine coupled to the OSD controller and the display screen. The control system further comprises an audio processor such as a digital sound processor coupled to the micro processor and the sound projector. The audio input connections preferably include conventional audio input connections. The sound projector preferably comprises an array of speakers configurable to inject beams of sound into a room in which the TV is located, which reflect off the walls and ceiling to create surround sound, and configurable to inject one or more targeted beams of sound into the room.

In operation, the user using the menu system and graphical user interface displayable on the screen of the TV and generated by the control system software, can select between different modes of operation including stereo, surround, mono targeted, dual targeted and the like, configure the sound projection system for the user viewing room and component configuration, and automatically calibrate or customize the sound beam parameters of the sound projection system using a microphone couplable to the control system or manually adjust the sound beam parameters by navigating the graphical user interfaced based menu system. Once the room, component and sound beam parameters are entered, the control system will draw graphical representations of the sound beams and display the graphical representations of the sound beams within a graphical representation of the user's viewing room on the TV screen. The user can further use the graphical user interfaced menu system to move the sound beams around the viewing room while being presented with a graphical representation of the same.

In an alternate embodiment, a sound projection system preferably includes a television with an integral sound projector and a rear sound projector operably coupled to the TV. The rear and integral sound projectors comprise arrays of speakers operable to jointly create surround sound within a room in which the TV is located and project one or more beams to targeted locations within the room. The arrays of speakers in the integral and rear sound projectors are configurable to inject beams of sound into a room in which the TV is located, which reflect off the walls and ceiling of the room to create surround sound. By adding the rear surround projector, it is possible to get very good rear surround audio channel performance and also improve the Left/Right channel performance.

Other systems, methods, features and advantages of the invention will be or will become apparent to one with skill in the art upon examination of the following figures and detailed description.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic of a television with an integral sound projector and control system.

FIG. 2 depicts a graphical user interfaced based menu displayed on the screen of the television with the sound projector configuration menu displayed.

FIG. 2A depicts a graphical user interfaced based menu displayed on the screen of the television with the sound projector configuration menu and custom soft key drop down menu displayed.

FIG. 2B depicts a graphical user interfaced based menu displayed on the screen of the television with the audio mode drop down menu displayed.

FIG. 3A depicts a graphical user interfaced based menu displayed on the screen of the television with the sound projector surround mode custom setup menu displayed with a graphical tracing of the paths of the sound beams displayed.

FIG. 3B depicts a graphical user interfaced based menu displayed on the screen of the television with the sound projector surround mode custom setup menu displayed with a graphical tracing of the paths of the sound beams displayed as modified by the user.

FIG. 4 depicts a graphical user interfaced based menu displayed on the screen of the television with the sound projector stereo mode custom setup menu displayed.

FIG. 5 depicts a graphical user interfaced based menu displayed on the screen of the television with the sound projector mono-target mode custom setup menu displayed.

FIG. 6 depicts a graphical user interfaced based menu displayed on the screen of the television with the sound projector dual-target mode custom setup menu displayed.

FIG. 7 depicts a schematic of a television with an integral sound projector and a rear sound projector coupled to the television.

FIG. 8 depicts a schematic of a graphical tracing of the paths of sound beams for surround mode.

FIG. 9 depicts a schematic of a graphical tracing of the paths of sound beams for surround mode.

FIG. 10 depicts a schematic of a graphical tracing of the paths of sound beams for surround mode.

FIG. 11 depicts a schematic of a graphical tracing of the paths of sound beams for target mode projection.

### DETAILED DESCRIPTION

The systems and methods described herein are directed to a television with an integral sound projection system and the control and operation of the television and integral sound projection system. More particularly, in one embodiment the television includes an integral sound projector comprising an array of speakers operable to create surround sound within a room and project one or more beams to targeted locations. The array of speakers is configurable to inject beams of sound into a room in which the TV is located, which reflect off the walls and ceiling of the room to create surround sound. The array of speakers is also configurable to inject one or more beams of sound into the room and target the one or more beams to desired locations within the room. A detailed description of stand alone sound projectors and sound projection systems that are external to the TV, i.e., not integrally located within the TV, and couplable to a TV and the operation of such sound projectors and sound projector systems are described in EP 1921890A2, U.S. 2006/0204022A2, WO 02/078388A2, WO 2007/007083A1 and U.S. 2004/0151325A1, which are incorporated herein by reference.

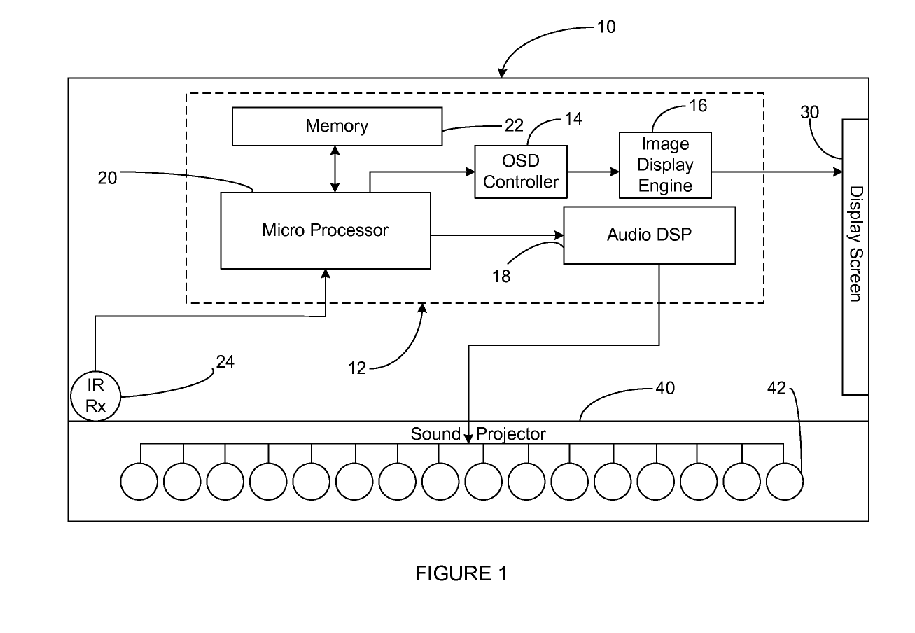

Turning in detail to the figures, FIG. 1 depicts a schematic of an embodiment of a television 10 with an integral sound projector 40 comprising an array of speakers 42. As shown in FIG. 1, the television 10 preferably comprises a video display screen 30, an IR signal receiver 24 and the sound projector 40 coupled to a control system 12. The control system 12 preferably includes a micro processor 20 and non-volatile memory 22 upon which system software is stored, an on screen display (OSD) controller 14 coupled to the micro processor 20 and an image display engine 16 coupled to the OSD controller 14 and the display screen 30. The control system 12 further comprises an audio processor 18, such as an audio digital sound processor (DSP) or the like, coupled to the micro processor 20 and the sound projector 40.

The system software preferably comprises a set of instructions that are executable on the micro processor 20 and/or the audio processor 18 to enable the setup, operation and control of the television 10 including the setup, operation and control of the sound projector 40. The system software provides a menu-based control system that is navigatable by the user through a graphical user interface displayed or presented to the user on the TV display 30. While on the TV layer of the TV remote control unit, the user can navigate the graphical user interface to setup, operate and control the TV 10, its integral sound projector, and external A-V input devices, such as, e.g., a DVD, a VCR, a cable box, and the like, coupled to the TV 10. A detailed discussion of a graphical user interface-based menu control system and its operation is provided in U.S. Published Patent Application No. U.S. 2002-0171624 A1, which is incorporated herein by reference.

In operation, the user using the menu system and graphical user interface displayable on the screen 30 of the TV 10 and generated by the system software executed on the micro processor 20, can select between different modes of audio operation including stereo, surround sound, targeted single or mono sound beam, targeted dual sound beams and the like. Using the graphical user interface based menu system, the user can also configure the sound projection system in accordance with the user's viewing room parameters such as room dimensions, TV location, distance of couch or main seating area from the TV. Once the sound projection system is configured in accordance with the user's viewing room parameters, the user can select to automatically calibrate the sound beam levels using a microphone couplable to the control system. Alternatively, the user can navigate the graphical user interface based menu system to adjust the sound beam parameters such as sound beam levels and angels. Once the viewing room and sound beam parameters are entered or received by the control system, the control system will draw graphical representations of the sound beams and display the graphical representations of the sound beams within a graphical representation of the user's viewing room on the TV display screen 30. The user can further use the graphical user interfaced menu system to adjust the angles of the sound beams and move the sound beams around the viewing room while being presented with a graphical representation of the same.

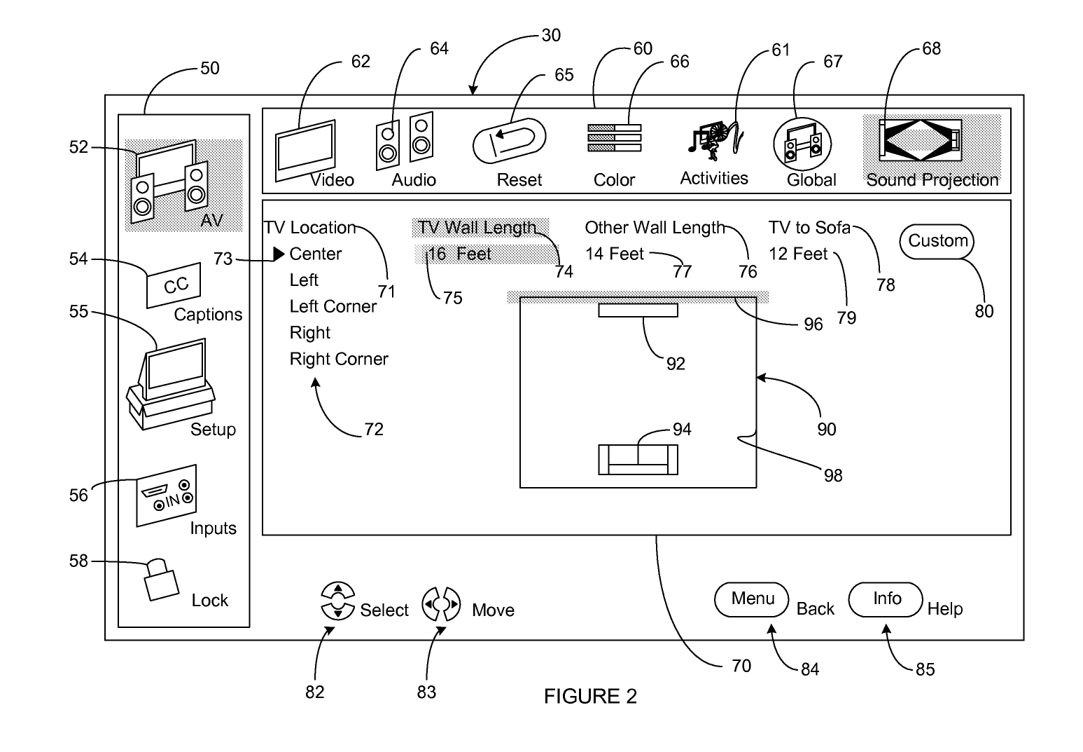

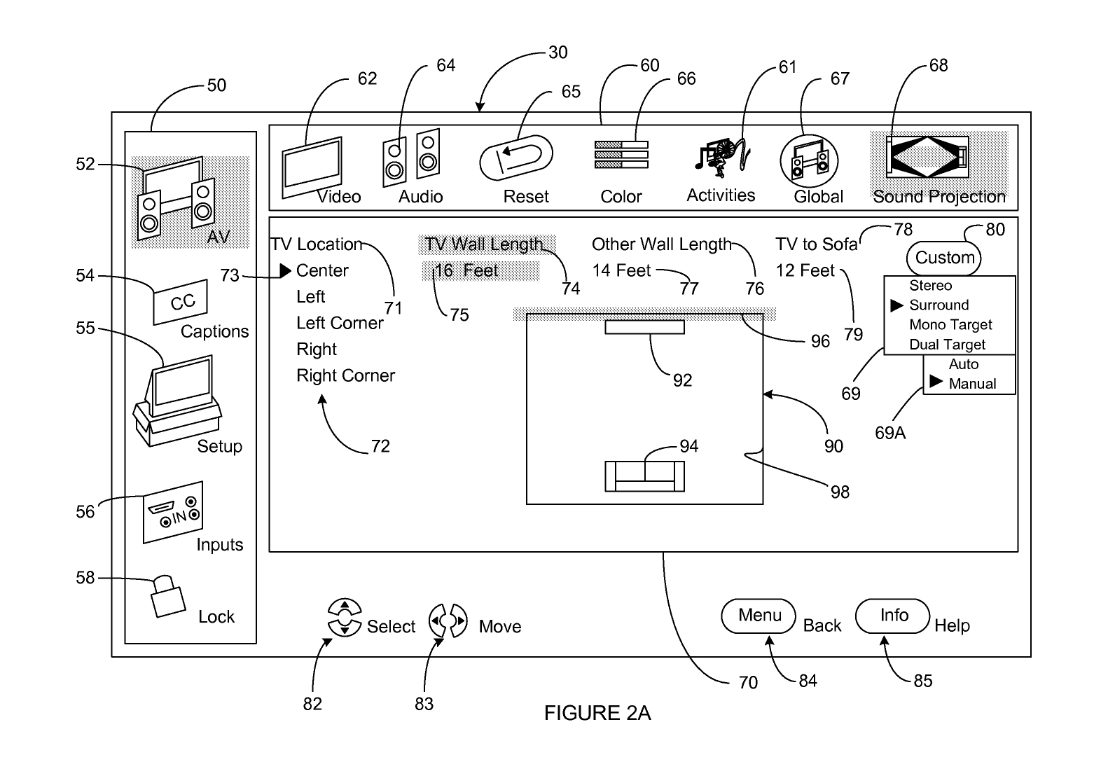

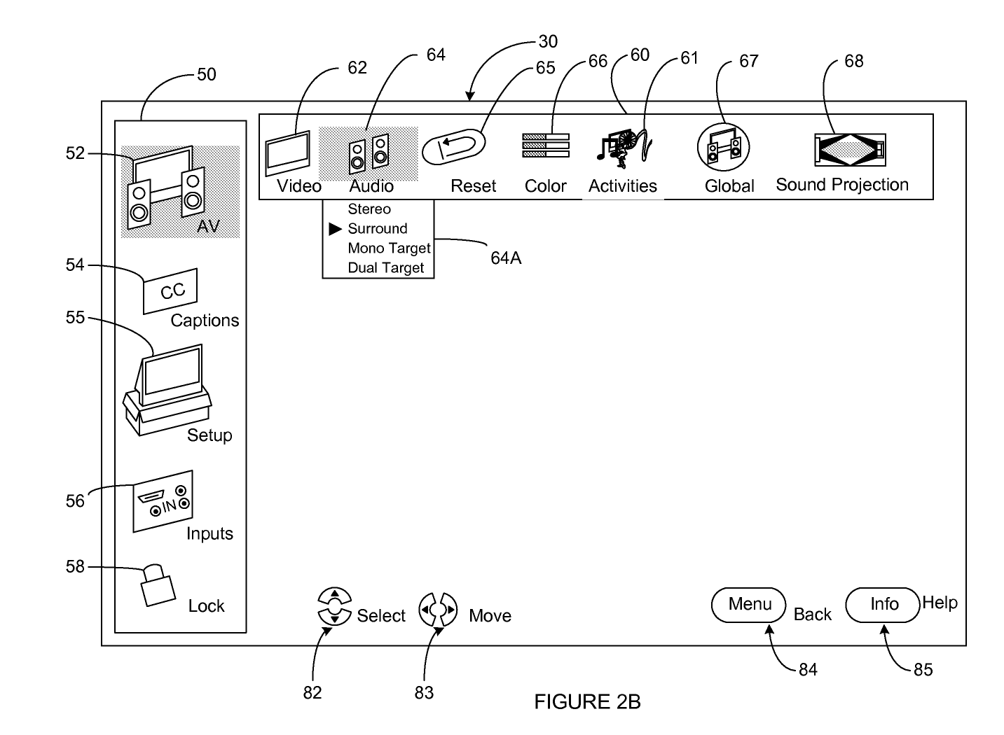

Turning to FIG. 2, configuring the sound projection system using the TV's graphical user interfaced-based multi-layer menu system will be discussed. Upon pressing the menu key on a control panel on the TV 10 or on a remote control unit, the user is presented with a system configuration menu 50 preferably along the left side of the screen 30. The configuration menu 50 preferably comprises selectable graphical icons representing menu options corresponding to functions and/or devices the user can configure such as, e.g., AV devices 50, captions 54, “out of the box” system setup 55, input devices 56 and security systems 58. The user is also presented with a navigation key or guide indicating which keys to press on the remote control to accomplish navigation functions such as “select” 82, “move” 83, “back” 84 and “help” 85. Highlighting, as depicted using gray shading about the icon for the AV device 52 menu option, is used to indicate location within a menu and selected menu item.

Upon selecting the AV device 52 menu option in the system configuration menu 50, a device configuration menu 60 is preferably displayed along the top of the screen 30. The device configuration menu 60 preferably includes selectable graphical icons representing menu option corresponding to functions or devices such as, e.g., video 62, audio 64, reset 65, picture color 66, internet 67, sound projection 68 and the like.

Upon selecting the sound projection 68 menu option in the device configuration menu 60, a sound projection system configuration menu 70 is displayed in the central portion of the screen 30. The sound projection system configuration menu 70 includes an image 90 comprising a graphical representation of the user's TV viewing room, and list of the viewing room parameters such as, e.g., TV location 71, TV wall length 74, other wall length 76 and distance from the TV to a sofa or primary seating area 78, which are needed by the system software to configure the projection sound system to inject sound beams into the viewing room and reflect the sound beams off the walls and ceiling to create surround sound. As depicted in the image of the viewing room 90, the TV wall length parameter 74 refers to the length of a wall in the user's TV viewing room corresponding to the wall 96 that the TV 92 is depicted as positioned on, the other wall length parameter 76 refers to the length of a wall in the user's TV viewing room corresponding to the wall 98 that the TV 92 is not depicted as positioned on, and the TV to sofa parameter 78 refers to the distance between a TV and a sofa or primary viewing area in the user's TV viewing room corresponding to the TV 92 and sofa 94 as depicted in the image of the viewing room 90.

As the selector indicator arrow 73 is moved from one TV location option 72 to another, the TV 92 is preferably depicted at the selected position 72 along wall 96 in the image of the viewing room 90. The user can navigate between the viewing room parameters and enter parameter values 75, 77 and 79.

With the room parameters entered by the user and received by the control system 12, the system software calculates the beam angles for five surround sound beams such as, e.g., front right, front left, center, rear right and rear left beams, to emanate from the speaker array 42 of the sound projector 40 and orients or configures the individual speakers of the speaker array 42 accordingly.

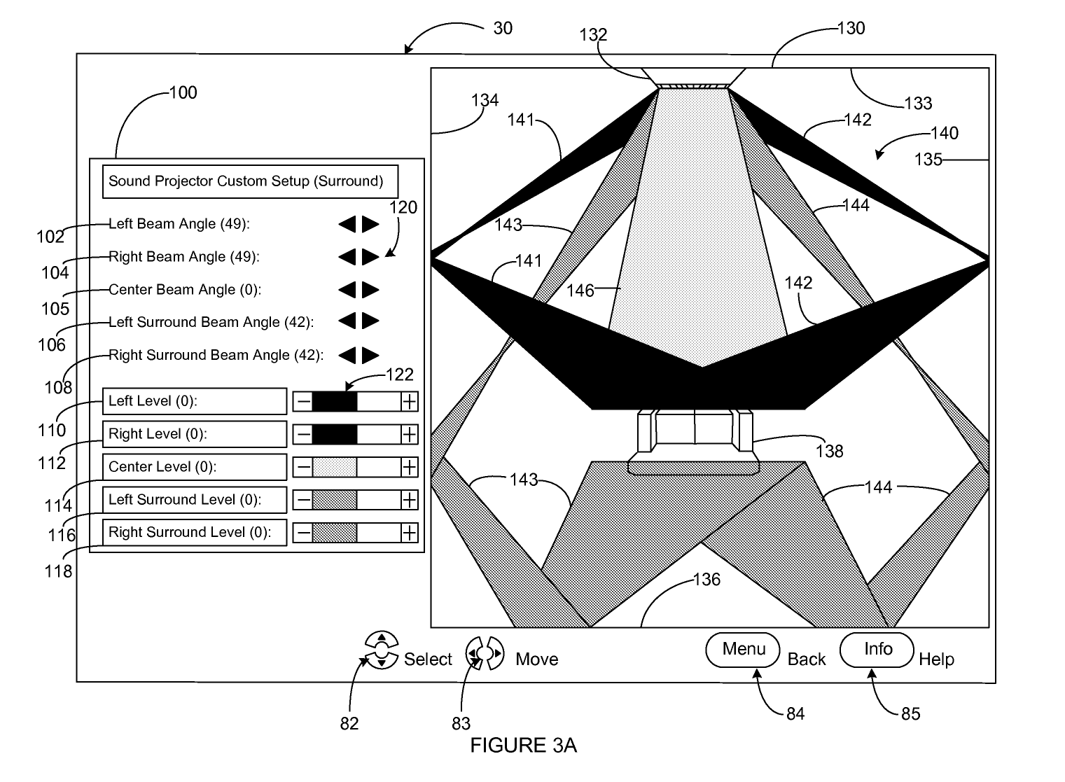

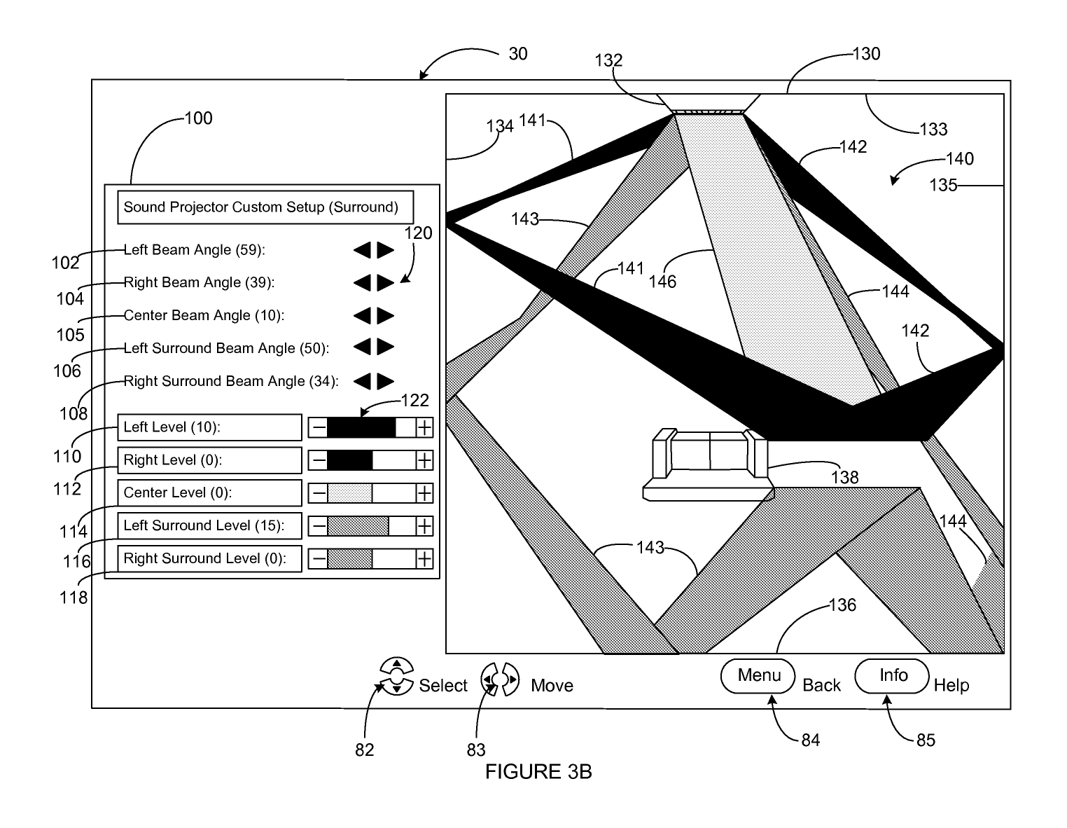

By selecting the soft key 80 labeled “custom” in the sound projection configuration menu 70, the user is presented as depicted in FIGS. 3A and 3B with graphical traces 140 of the paths the sound beams will follow or follow in the TV viewing room. The traces 140 corresponding to, e.g., a front left sound beam 141, a front right sound beam 142, a center sound beam 146, a rear left sound beam 143, and a rear right sound beam 144 of surround sound, are displayed on the screen 30 in an graphical image 130 representing the TV viewing room with a front or TV wall 133, a back wall 136, side walls 134 and 135, a TV 132 positioned along the TV wall 133 and a couch 138 positioned within the image 130 of the TV viewing room in spaced relation with the TV 132.

As one skilled in the art would readily understand, audio sound beams reflect off the walls of the TV viewing room following the general law of reflection in physics of “angle of incidence equals angle of reflection”. The function within the system software that draws the traces 140 includes a loop that draws each segment of a sound beam as a polygon. The corner points of the polygon are calculated through a “point bounce” function that finds the points where a straight line will bounce when shooting the line from a particular point in at a particular angle in a room of particular dimensions, and then uses the law of reflection to return the bounce angles on the room walls. Each side of the beam is calculated separately, but when drawn on the screen the two side lines of a beam represents four end points of a beam polygon.

Representative software code corresponding to the “point bounce” function preferably includes:

while (drawing beam segments)
{

If (beam segment starts above sofa)
{

If (beam segment hits sofa)
{

Draw polygon of beam to stop at sofa level (from top);

}
else
{

Draw polygon of beam to hit next bounce points on wall.
If (beam hits corner of room)
{

Terminate further beam drawing, illegal reflection;

}

}

}
else //beam segment starts below sofa
{

If (beam segment hits sofa)
{

Draw polygon of beam to stop at sofa level (from bottom);

}
else
{

Draw polygon of beam to hit next bounce points on wall;

}

}
Beginning of next beam segment is set equal to end of previous beam
segment;

}
The “sofa level” is the horizontal line of where the sofa is.

In order to efficiently draw the polygons and display the polygons on the screen 30 as shown in FIG. 3A and move them about the room as depicted in FIG. 3B in response to a user depressing the right or left cursor keys 83 on the remote control, the registers of the sound processor 18 are synchronized with the electronic key of the remote control. Process for controlling the synchronization of the sound processor registers with the key of the remote control includes translating the electronic key of the remote control into a two's complement number used directly in setting up and controlling the registers for each of the discrete channels in the sound processor. The keys are interpreted in real time such that when a user presses a left or right cursor key on the remote control, the bits from the electronic key of the remote control are converted into two's complement number which is then generated and sent to the sound processor 18 to synchronize the discrete channel.

The method for efficiently rendering polygons is based on the electronic key repeats of the remote control. Efficiently rendering multiple polygons on the screen 30 to simulate sound beam reflections requires the methods of flipping the pixel images to transparency and back to a specific color and location such that the polygon images appears to be a new pixel location with each iteration. Converting the image to transparency provides a clean base for the next iteration. The method for efficiently rendering polygons is effectively an internal iterator that is controlled by electronic key rate of the remote control. The faster the rate the faster the images are converted to transparency to provide a clean base for the next iteration and rendering.

Turning back to FIGS. 2A and 2B, the user can select the “custom” soft key 80 in the sound projection configuration menu 70, to view and adjust the approximate angles of the sound beams as represented by the graphical polygon traces 140 as depicted in FIGS. 3A and 3B. As depicted, a sound projector setup menu 100 is displayed on the screen 30 along with the image 130 of the TV viewing room containing graphical polygon traces 140. The sound projector setup menu 100 includes selectable menu options with current value settings indicated that correspond to the left beam angle 102, the right beam angle 104, the center beam angle 105, the left surround beam angle 106, and the right surround beam angle 108. The value of each beam angle can be adjusted by pressing the right or left cursor keys 83 on the remote control as indicated by menu key or guide 120. As the cursor keys 83 are pressed, the indicated angle value of the selected menu option will change as well as the angle and, thus, position of the corresponding polygon trace, the results of which are depicted in FIG. 3A, enabling the user to visually move the sound beams around the room to approximate locations.

In addition, the sound projector setup menu 100 includes selectable menu options with current value settings indicated that correspond to the sound level of left beam 110, the right beam 112, the center beam 114, the left surround beam 116, and the right surround beam 118. The level of each beam can also be adjusted by using the slider 122.

As graphically depicted in FIGS. 2A, 2B, 3A, 3B, 4, 5 and 6, the TV 10 with integral sound projector 40 can operate in a variety of audio modes including surround, stereo and single or multiple targeted beams. As depicted in FIG. 2A, when the “custom” soft key 80 is selected, an audio mode configuration drop down menu 69 or the like is displayed prompting the user to select an audio mode of operation to configure. Once an audio mode is selected, an auto/manual drop down menu 69A or the like is displayed prompting the user to select automatic or manual configuration of the selected audio mode of operation. If the “automatic” option is selected, the sound beam levels will automatically be calibrated as discussed below based on the current viewing room and beam parameter settings. If the “manual” option is selected, a sound projection custom setup menu and TV viewing room image will be displayed on the screen 30 prompting the user to adjust the beam angle and/or beam level as depicted in and discussed above with regard to FIG. 3.

As depicted in FIG. 2B, the user can select an audio mode of operation by selecting the Audio icon 64 in AV device configuration menu 60. When Audio icon 64 is selected, an audio mode selection drop down menu 61 or the like is displayed prompting the user to select a desired audio mode of operation. Adjustment of the audio mode settings can be made by returning the sound projection configuration menu 70 and selecting the custom soft key 80.

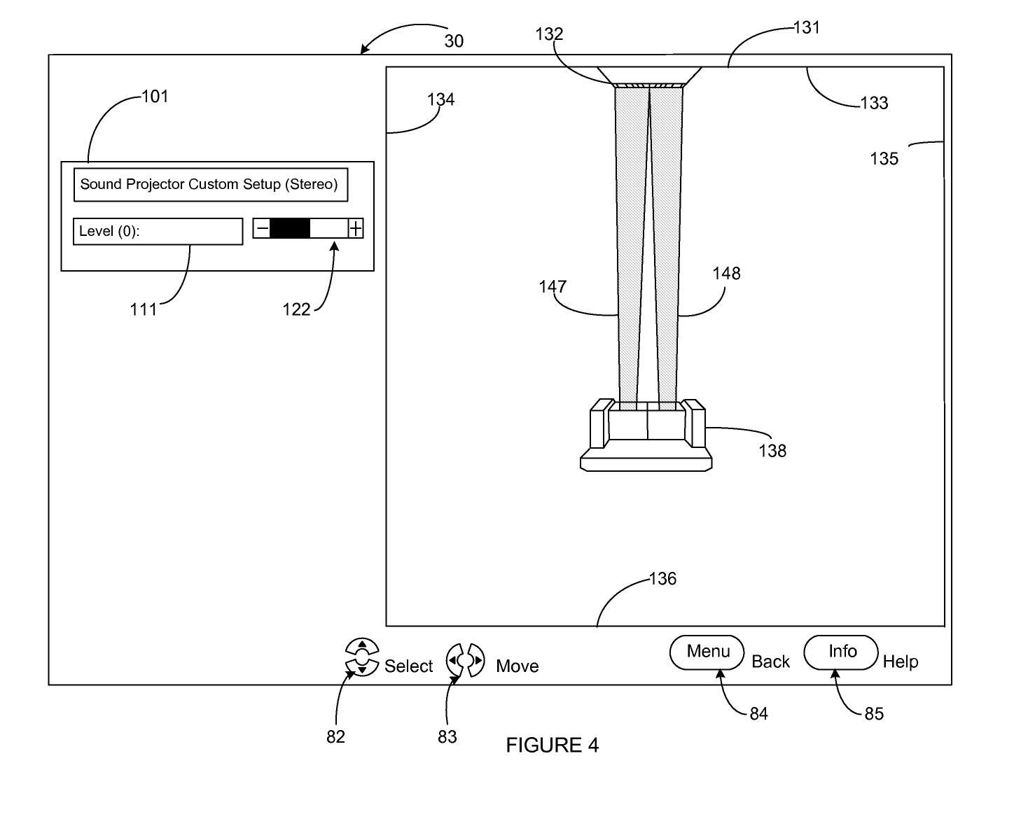

If the custom soft key 80 is selected and manual configuration of the stereo mode is selected from the audio mode configuration menus 69 and 69A, as depicted in FIG. 4, a sound projector custom setup menu 101 for stereo mode and a TV viewing room image 131 graphically depicting left and right stereo beams 147 and 148 emanating from the sound projector of the TV 132 are displayed on the screen 30. As depicted, the sound projector custom setup menu 101 preferably only includes a menu option corresponding to the sound level 111 of the beams 147 and 148, which can be adjusted with slide 122. Alternatively, the sound projector custom setup menu 101 can include a beam angle adjust menu option to adjust the angle of the stereo sound beams 147 and 148 to move beams around the room.

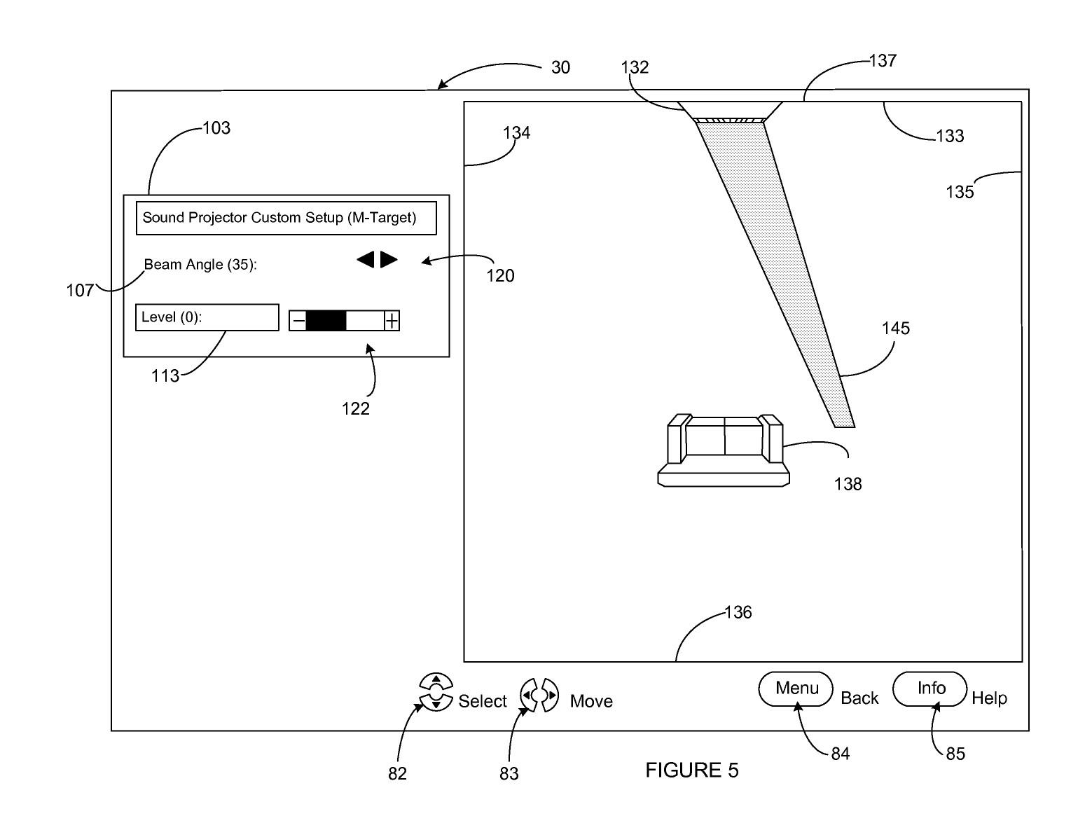

If the custom soft key 80 is selected and manual configuration of the single or mono target beam mode is selected from the audio mode configuration menus 69 and 69A, as depicted in FIG. 5, a sound projector custom setup menu 103 and a TV viewing room image 137 graphically depicting a single or mono sound beam 145 emanating from the sound projector of the TV 132 are displayed on the screen 30. As depicted, the sound projector custom setup menu 103 preferably includes a menu option corresponding to a beam angle 107 of the mono beam. As indicated, the beam angle value can be adjusted to move the mono sound beam around the room to approximate targeted locations within the room. In addition, the sound projector custom setup menu 103 preferably includes a menu option corresponding to the sound level 113 of the mono beam, which can be adjusted with slide 122.

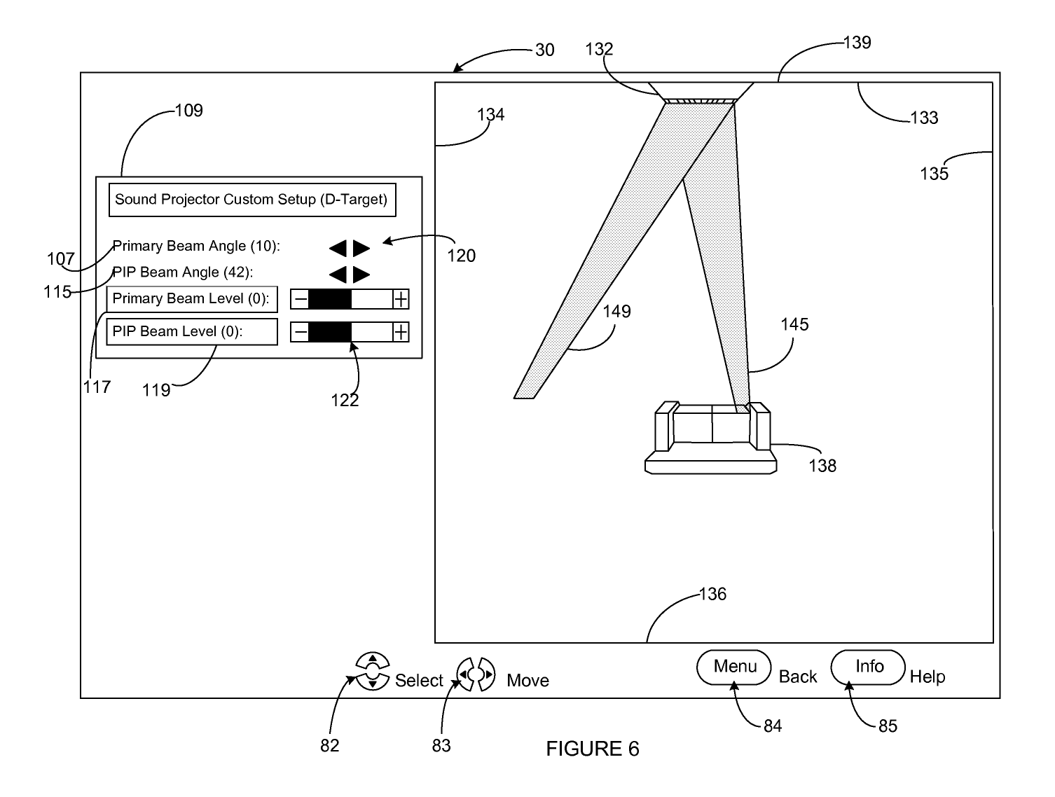

If the custom soft key 80 is selected and manual configuration of the dual target beam mode is selected from the audio mode configuration menus 69 and 69A, as depicted in FIG. 6, a sound projector custom setup menu 109 and a TV viewing room image 139 graphically depicting two or dual sound beams 145 and 149 emanating from the sound projector of the TV 132 are displayed on the screen 30. As depicted, the sound projector custom setup menu 109 preferably includes menu options corresponding to beam angles 107 and 115 of the two beams 145 and 149. As indicated, the beam angle value can be adjusted to move the two sound beams around the room to approximate targeted locations within the room. As suggested by the use of the term PIP in the menu, the dual beam mode can be used to allow two viewers to watch picture-in-picture or split screen video with the one beam or the primary sound beam 145 being assigned to the main picture or one of the pictures in the split screen and the other beam or PIP sound beam 149 being assigned to the PIP or other picture in the split screen.

In addition, the sound projector custom setup menu 109 preferably includes menu options corresponding to the sound levels 117 and 119 of the two beams, which can be adjusted with the slide 122.

As discussed above, rear surround audio channel performance can be weak using a sound projector as discussed above in larger rooms or in room configurations that do not include a rear wall in the room in which the TV is located. In an alternative embodiment, a sound project system preferably includes a television with an integral sound projector as discussed above and a rear sound projector operably coupled to the TV. The rear and integral sound projectors comprise arrays of speakers operable to jointly create surround sound within a room in which the TV is located and project one or more beams to targeted locations within the room. The arrays of speakers in the integral and rear sound projectors are configurable to inject beams of sound into a room in which the TV is located, which reflect off the walls and ceiling of the room to create surround sound. By adding the rear sound projector, it is possible to get very good rear surround audio channel performance and also improve the Left/Right channel performance.

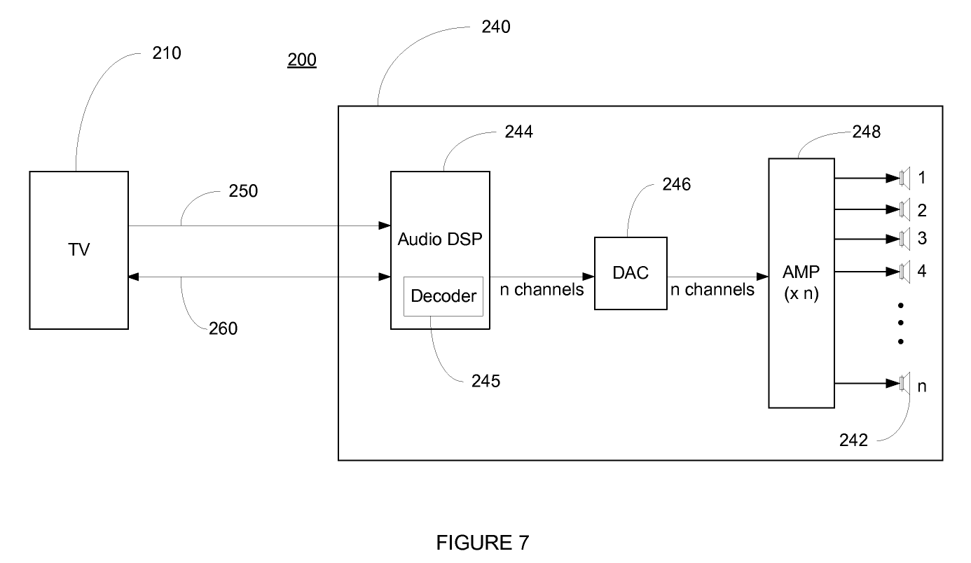

Referring to FIG. 7, a sound projection system 200 is depicted to include a TV 210 having an integral sound projection system 40 and control system 12 as discussed above with regard a TV 10 shown in FIG. 1. A rear sound projector 240 is coupled to the TV 210 to receive audio and control signals 230 and 260 over wired or wireless connections 250 and 260. The rear sound projector 240 preferably includes an audio DSP controller 244 operably coupled to the audio DSP 18 of the TV 210. The audio signal 250 can be transmitted from the TV audio DSP 18 as a Sony Philips Digital InterFace (SPDIF) signal. The audio DSP controller 244 of the rear sound projector 240 includes a decoder 245 to decode the SPDIF signal. If the Left, Right, Left Surround and Right Surround channel signals are sent independently, the need for the decoder 245 would be avoided.

A digital-to-analog converter (DAC) 246 is coupled the audio DSP 244 and an n channel amplifier 248. An array of n speakers 242 is coupled to the amplifier 248.

In operation, the microprocessor 20 instructs the audio DSP 18 to configure the speaker arrays 42 and 242 of the integral and rear sound projectors 40 and 240 in accordance with the desired audio mode selected by a viewer and the room size and viewing location parameters. The microprocessor 20 instructs the audio DSP 18 to configure the speaker array 42 of the integral sound projector 40 and the microprocessor 20 instructs the audio DSP 244 of the rear sound projector 240 to configure the speaker array 242 of the rear sound projector 240 in accordance with the desired audio mode selected by a viewer and the room size and viewing location parameters.

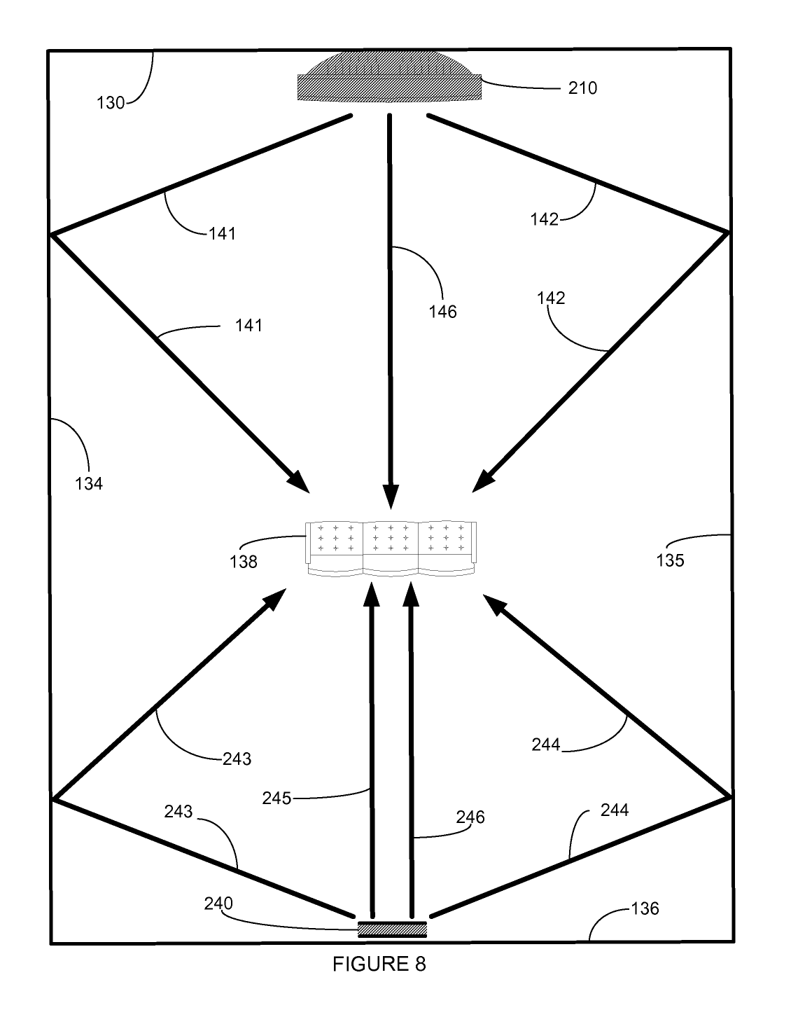

Turning to FIGS. 8 through 11, the traces of beams of sound injected into a room are depicted under different configurations of the sound projection system 200 comprising a TV 210 with an integral sound projector and a rear sound projector 240 coupled to the TV 210. The room is defined by a front wall 130, side walls 134 and 135, and rear wall 136 with a TV 210 positioned along the front wall 130 and a couch 138 positioned within the TV viewing room in spaced relation with the TV 210. With the rear projector 240 configured for four beams, the beams of sound projected into the room include a front left sound beam 141, a front right sound beam 142, a center sound beam 146, a rear left sound beam 243, a rear right sound beam 244, a left surround sound beam 245 and a right surround sound beam 246 as depicted in FIG. 8.

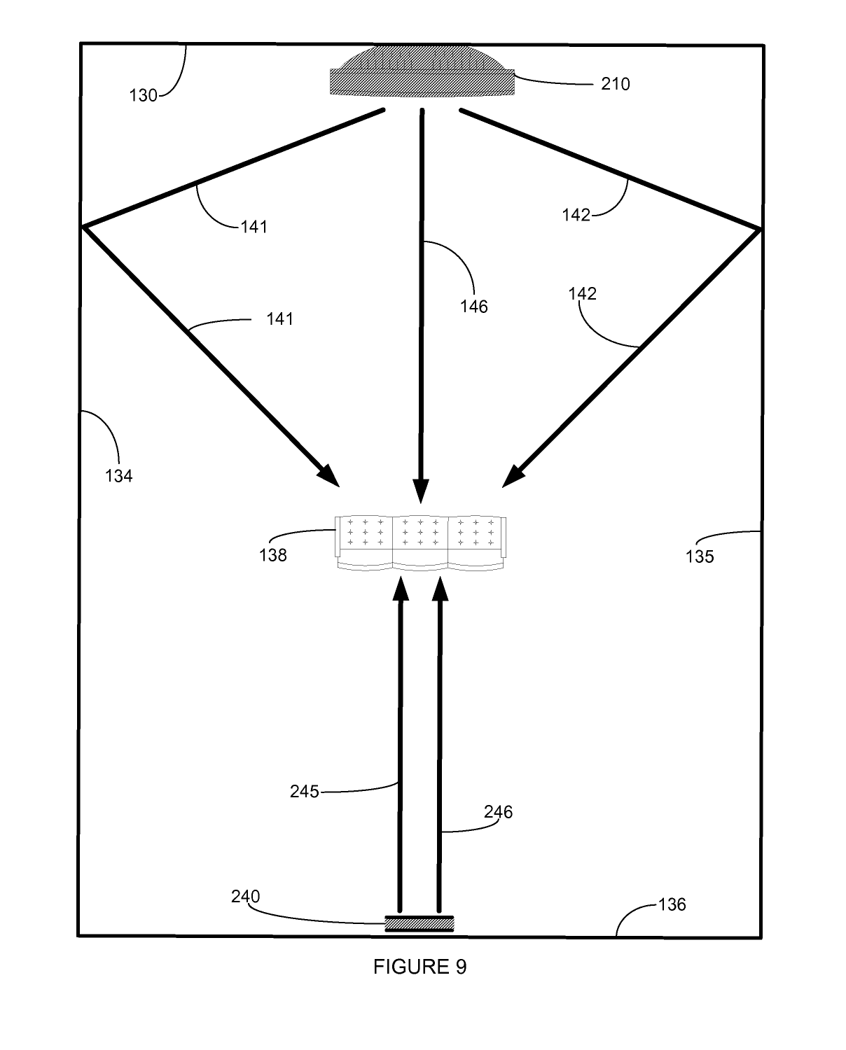

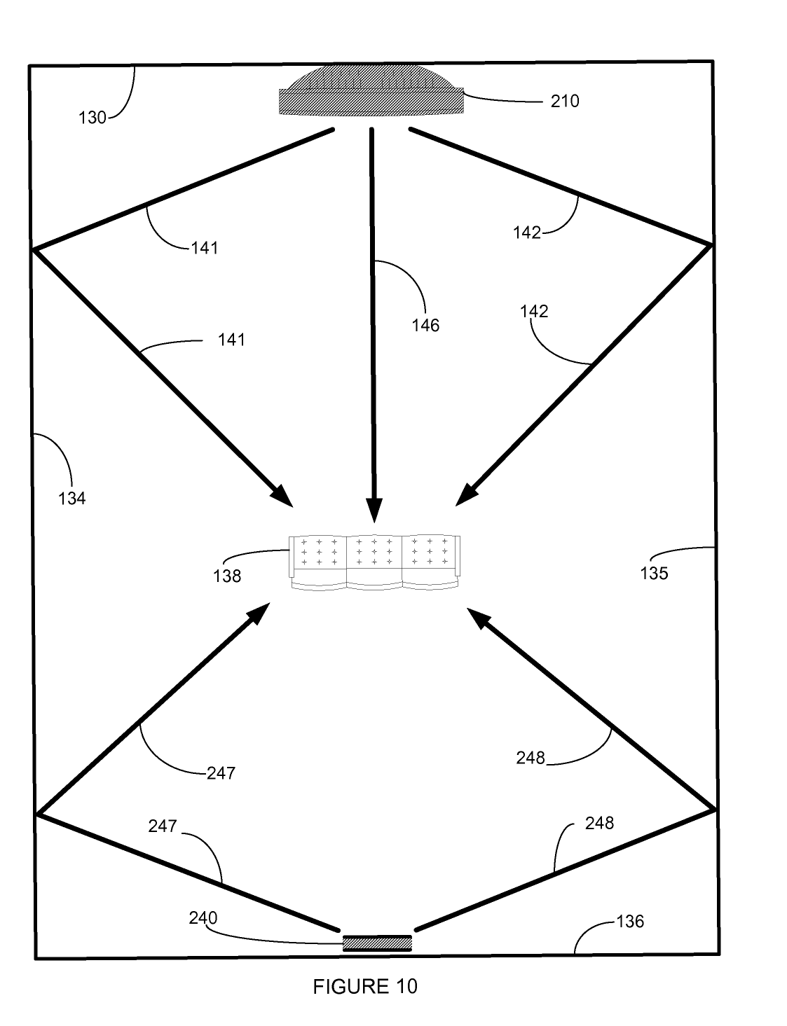

Referring to FIGS. 9 and 10, the rear sound projector 240 is configured for two beams with the configuration of the integral sound projector unchanged. As depicted FIG. 9, the rear sound projector 240 is configured to inject left and right surround sound beams 245 and 246 directly at the listening position on the sofa 138. As depicted FIG. 10, the rear sound projector 240 is configured to inject the left and right surround sound beams 247 and 248 into the room to deflect off of the side walls 134 and 135 toward the listening position on the sofa 138.

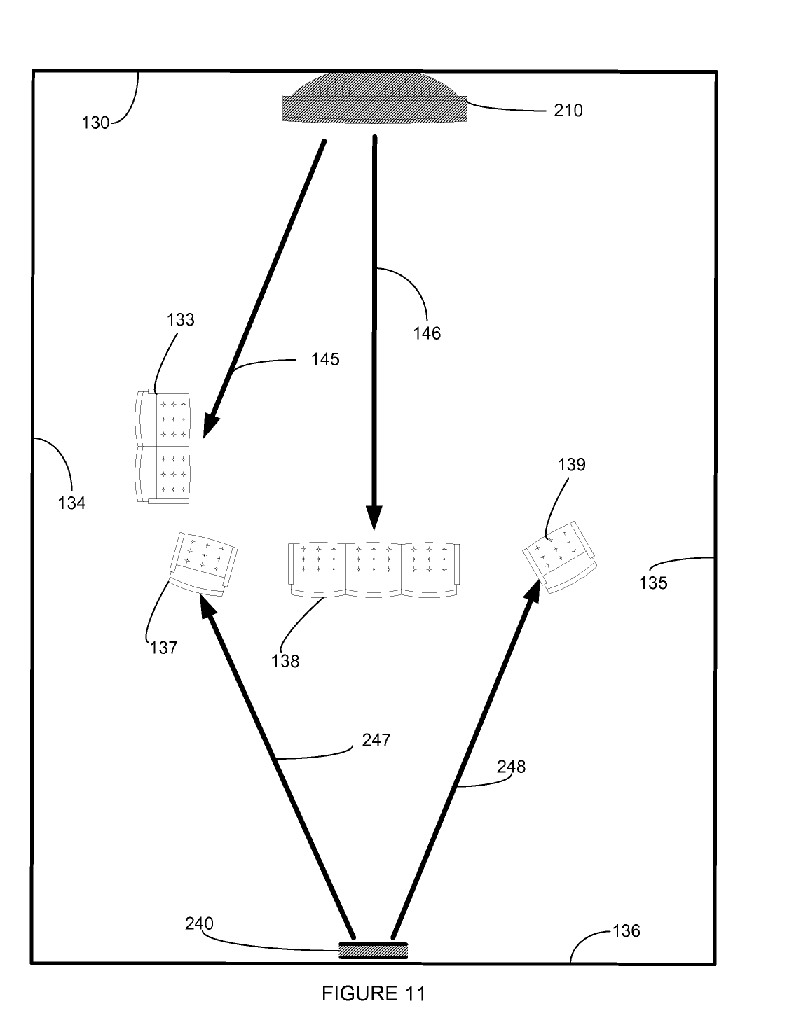

Turning to FIG. 11, the sound projection system 200 is configured to inject beams into the room directed to a plurality of listening positions. As depicted, the integral sound projected 40 is configured to inject beams into the room directed to a first and second listening position 133 and 138 while the rear sound projector is configured to inject beams into the room directed to third and fourth listening positions 137 and 139.

As described in detail above, the user can navigate the graphical user interface based menu system to adjust the sound beam parameters such as sound beam levels and angels. Once the viewing room and sound beam parameters are entered or received by the control system, the control system will draw graphical representations of the sound beams and display the graphical representations of the sound beams within a graphical representation of the user's viewing room on the TV display screen 30. The user can further use the graphical user interfaced menu system to adjust the angles of the sound beams and move the sound beams around the viewing room while being presented with a graphical representation of the same.

As one skilled in the art would readily recognize, this process can be used for the automatic setup of audio levels and delays in surround systems with TVs that serve the AVR function and include an integral surround sound decoder and either a sound projector, a power amplifier or wireless transmitters for discrete external speakers.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A surround sound audio-video system comprising
a television having a display screen, an integral a sound projector, and a control system coupled to the display screen and sound projector, and
a rear sound projector coupled to the TV, wherein the control system is configured to cause the integral sound projector and the rear sound projector to project a plurality of sound beams into a room toward target locations.

2. The system of claim 1 wherein the rear sound projector is configured to receive audio and control signals from the television.

3. The system of claim 2 wherein the control system includes a first audio digital sound processor.

4. The system of claim 3 wherein the rear sound projector includes a second audio digital sound processor operably coupled to the first audio digital sound processor.

5. The system of claim 4 wherein the rear sound projector includes a digital-to-analog converted coupled to the second digital sound processor and an multi channel amplifier.

6. The system of claim 5 wherein the rear sound projector includes a speaker array of N speakers coupled to the multi channel amplifier, wherein the amplifier includes N channels.

7. The system of claim 1 wherein the control system includes a graphical user interface including graphical representation of the projected path of the one or more sound beams and operable by a user to adjust the angles of the projected path of the one or more sound beams.

8. The system of claim 1 wherein the control system causes the output of sound in an output mode associated with a selected viewing activity.

9. The system of claim 1 wherein the interface prompts a user to input information using a menu-driven format.

10. A method of operation of a surround sound audio-video system including a TV with an integral sound projector embedded in the TV and a rear sound projector operably coupled to the TV, comprising the steps of
prompting a user to enter a first parameter regarding room size, a second parameter regarding TV location, and a third parameter regarding viewing distance from TV,
calculating beam angles for sound beams emanating from the integral sound projector embedded in the TV and the rear sound projector operably coupled to the TV, and
projecting the sound beam from the integral sound projector embedded in the TV and the rear sound projector operably coupled to the TV.

11. The method of claim 10 further comprising the steps of
drawing a first set of polygons corresponding to paths of the sound beams emanating from the integral sound projector embedded in the TV and the rear sound projector operably coupled to the TV, and
displaying the polygons on a screen of the TV.

12. The method of claim 11 further comprising the steps of drawing a second set of polygons corresponding to paths of the sound beams emanating from the integral sound projector embedded in the TV and the rear sound projector operably coupled to the TV resulting from a change in beam angles entered by a user of the TV.

13. The method of claim 10 further comprising the steps of
prompting a user to select a viewing activity,
prompting the user to select an audio mode of operation from a list of audio modes of operation including surround sound, stereo, mono targeted beam and dual target beam to be assigned to the viewing activity.

14. The method of claim 10 further comprising the steps of
receiving instructions to begin a viewing activity selected by the user,
displaying video content on the display screen in accordance with the viewing activity, and
outputting sound corresponding to the video content in accordance with the audio mode assigned to the viewing activity.

15. The method of claim 10 further comprising the steps of
receiving instructions to begin calibration of the integral sound projector embedded in the TV and the rear sound projector operably coupled to the TV,
sending bursts of a test signals for each sound beam, and
receiving IR signals with the measured level of sound beams.
